(19) United States
(12) Patent Application Publication
(10) Pub. No.: US 2016/0327093 A1
(43) Pub. Date: Nov. 10, 2016

(54) BEARING FOR USE IN DIRECTIONAL DRILLING

(71) Applicant: Michael D. Johns, Houston, TX (US)

(72) Inventor: Michael D. Johns, Houston, TX (US)

(21) Appl. No.: 15/148,586

(22) Filed: May 6, 2016

Related U.S. Application Data
(60) Provisional application No. 62/157,851, filed on May 6, 2015.

(51) Int. Cl. F16C 33/58; F16C 19/16; F16C 33/38; E21B 4/00

(52) U.S. Cl. CPC F16C 33/585; E21B 4/003; F16C 19/166; F16C 33/3806; E21B 7/04

(57) ABSTRACT

The present invention provides an improved bearing assembly having an insert with an insert race, a rolling element cage, a collar with a collar race and a plurality of rolling elements arranged so that the rolling elements engage both the insert race and the collar race, with the insert race and collar race on opposing sides of each rolling element such that a line through the mid-point of the insert race and the mid-point of the collar race is at a 45-degree angle to an axis of a throughbore of the insert with the components of the bearing assembly in the assembled condition.

### STATEMENT OF RELATED APPLICATIONS

This application depends from and claims priority to U.S. Provisional Application No. 62/157,851 filed on May 6, 2015.

### FIELD OF THE INVENTION

The present invention is directed to an improved mechanical bearing assembly for use in bottom hole assemblies used in directional drilling of boreholes that penetrate the earth's crust for recovery of mineral deposits. The improved bearing assembly enables an operator to use shorter bottom hole assembly which can achieve smaller radius bends in the pathway of the borehole for improved placement of borehole pathways and improved targeting of suspected mineral-bearing subsurface geologic formations. The improved bearing of the present invention also provides extended life compared to conventional bearing assemblies, thereby enabling an operator to drill more borehole without tripping out of the hole to replace the bottom hole assembly or the bearings within the bottom hole assembly.

### BACKGROUND

Conventional drilling systems often use bottom hole assemblies having a mud motor which is powered by high pressure drilling fluid pumped down a drill string. The mud motor has an output shaft that is rotated by operation of the mud motor. A drill bit is coupled to the output shaft for rotation against the formation rock that comprises a mineral-bearing reservoir. High pressure drilling fluid is pumped down the drill string to the mud motor, where it is used to power the mud motor and rotate the shaft extending distally from the mud motor and coupled to the drill bit. The low pressure drilling fluid emerging from the mud motor is introduced through a bore in the shaft and through the drill bit to suspend and remove drill cuttings from the extended bore hole.

Bearing assemblies used in conventional bottom hole assemblies have a limited life due to the extremely harsh conditions imposed on the bearing assemblies. These bearing assemblies are required to absorb both lateral impact and axial impact caused by the powered rotation of the drill bit against the formation rock to extend the borehole. The limited turning capacity and limited durability of conventional bearing assemblies used in bottom hole assemblies is costly and impairs drilling efficiency.

The improved bearing will be understood by the description provided below, which relates to the drawings appended hereto.

### BRIEF DESCRIPTION OF THE SEVERAL VIEWS OF THE DRAWINGS

FIG. 1 is an exploded and partially sectioned view of an embodiment of the improved bearing assembly of the present invention revealing an insert (shown in section), a rolling element cage (not in section), a plurality of rolling elements (not in section) and a collar (shown in section).

FIG. 2 is a perspective view of the assembled bearing assembly of FIG. 1. The prospective view of FIG. 2 reveals the collar top end, the insert top end therewithin, the upper end of the rolling element cage, and the collar exterior wall of the collar.

FIG. 3 is a plan view of the improved bearings of FIGS. 1 and 2 and reveals the rolling elements equi-angularly positioned by the rolling elements cage. The collar is surrounded by the collar exterior wall.

FIG. 4 is a sectioned view of the bearing assembly of FIG. 3 and shows the throughbore of the insert coinciding with the shoulder sleeve bore of the collar and the cage bore of the rolling element cage.

FIG. 5 illustrates that, for the embodiment of the bearing assembly of FIGS. 1-4, a line drawn through the mid-point of the insert race of the insert and the mid-point of the collar race of the collar forms a 45-degree angle with an axis of the throughbore of the insert of the bearing assembly.

### SUMMARY OF THE INVENTION

One embodiment of the bearing assembly of the present invention includes an insert having throughbore, a bearing race about an exterior of the insert, a shoulder radially protruding from the exterior of the insert, an insert top end, an insert bottom end opposite to the insert top end, an insert lower portion and a throughbore wall, a rolling element cage disposed adjacent to the insert and having a shoulder sleeve, a cage upper end, a convergent portion, a cage bore, an insert sleeve, a cage lower end, and a plurality of angularly distributed rolling element holes, a collar having a collar top end, a collar bottom end opposite to the collar top end, a collar exterior wall, a collar race with a radius equal to a radius of the insert race of the insert, a shoulder sleeve bore having an interior wall and an insert sleeve bore having an interior wall, and a plurality of rolling elements sized for being received into the rolling element holes of the cage and for bearing against the insert race of the insert and the collar race of the collar, wherein the cage maintains the plurality of rolling elements in and angularly distributed arrangement, and wherein a line through a mid-point of the insert race and a mid-point of the collar race will be at a 45-degree angle to an axis of the throughbore of the insert with the bearing assembly in an assembled condition.

### DETAILED DESCRIPTION

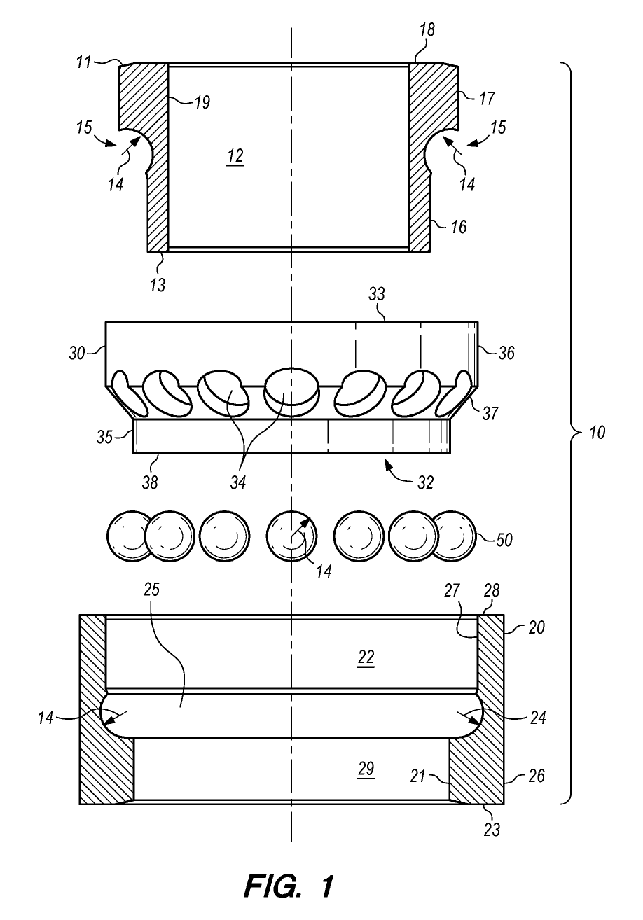

FIG. 1 is an exploded and partially sectioned view of an embodiment of the improved bearing assembly 10 of the present invention revealing an insert 11 (shown in section), a rolling element cage 30 (not in section), a plurality of rolling elements 50 (not in section) and a collar 20 (shown in section). While the components of the bearing assembly 10 of the present invention are illustrated in FIG. 1 in a vertical orientation, it will be understood that the bearing assembly 10 can be used in any orientation encountered in directional drilling of earthen boreholes.

The insert 11 at the top of FIG. 1 includes a throughbore 12, an exterior race 15 having a radius 14, a shoulder 17, insert top end 18, an insert bottom end 13, opposite to the insert top end 18, an insert lower portion 16 and a throughbore wall 19.

The roller bearing cage 30 depicted below the insert 11 includes a shoulder sleeve 36, a cage upper end 33, a convergent portion 37, a cage bore 32, an insert sleeve 35, a cage lower end 38, and a plurality of angularly distributed rolling element holes 34. It will be understood that the cage 30 positions and maintains the rolling elements 50 in a desired equiangular distribution about the cage bore 32.

Depicted below the cage 30 are a plurality of rolling elements 50 sized for being received into the rolling element holes 34 and for bearing against the insert race 15 of the insert 11. It will be understood that each of the rolling elements 50 has a radius 14 that is equal to the radius 14 of the insert race 15.

The collar 20 includes a collar top end 28, a collar bottom end 23, a collar exterior wall 26, a collar race 25 having a radius 14 equal to the radius 14 of the insert race 15 and equal to the radius 14 of the rolling elements 50, a shoulder sleeve bore 22 having an interior wall 27 and an insert sleeve bore 29 having an interior wall 21.

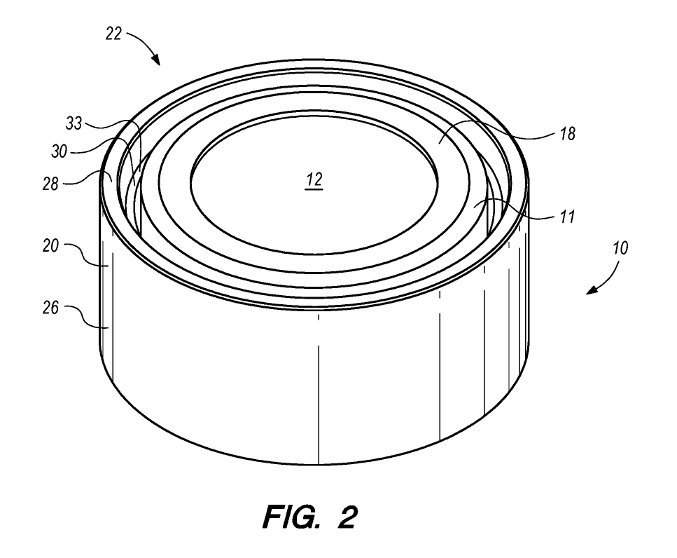

FIG. 2 is a perspective view of the assembled bearing assembly 10 of FIG. 1. The prospective view of FIG. 2 reveals the collar top end 28, the insert top end 18 therewithin, the upper end 33 of the rolling element cage 30, and the collar exterior wall 26 of the collar 20. The drive shaft (not shown) extending from a mud motor of a bottomhole assembly is received through the through bore 12 of the insert 11 shown in FIG. 2. The bearing assembly 10 provides for low-friction rotation of the drive shaft (not shown) received through the throughbore 12.

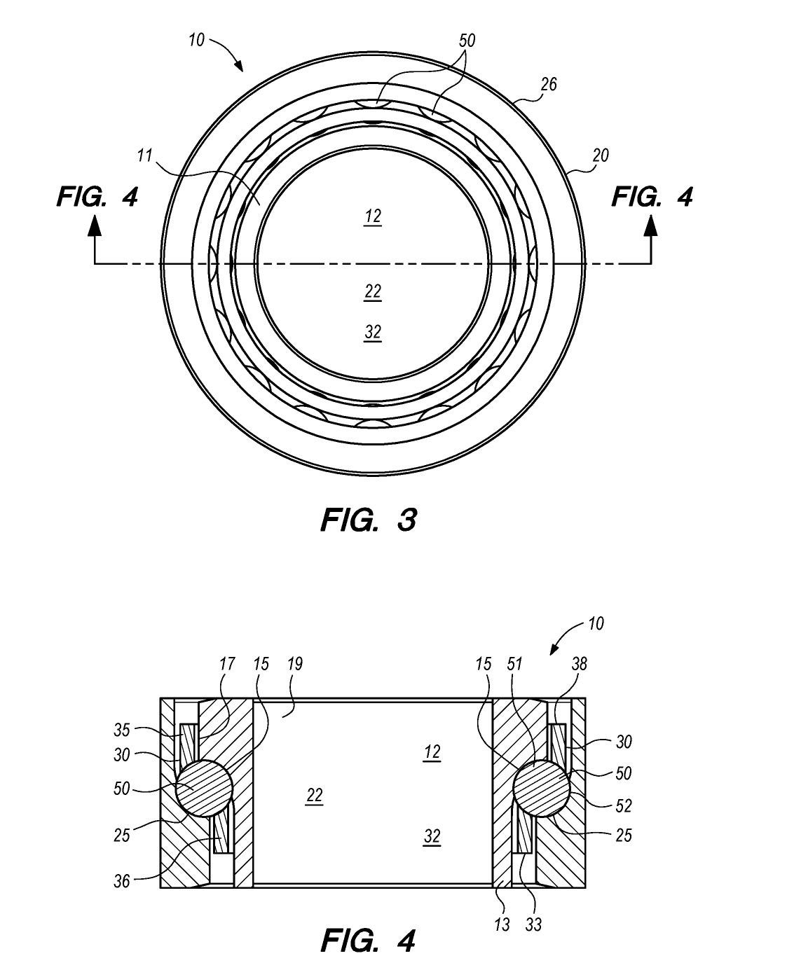

FIG. 3 is a plan view of the improved bearings of FIGS. 1 and 2. FIG. 3 reveals the rolling elements 50 equi-angularly positioned by the rolling elements cage 30. The collar 20 is surrounded by the collar exterior wall 26. The insert 11 surrounds the through bore 12, and the insert 11 is surrounded by the rolling elements cage 30, the plurality of rolling elements 50 and the collar 20. The radially upset shoulder 17 of insert 11, which is larger in diameter than the insert lower portion 16, is received within the shoulder sleeve bore 22 of the collar 20. The insert lower portion 16 is received within the insert sleeve bore 29.

FIG. 4 is a sectioned view of the bearing assembly 10 of FIG. 3. FIG. 4 shows the throughbore 12 of the insert 11 coinciding with the shoulder sleeve bore 22 of the collar 20 and the cage bore 32 of the rolling element cage 30. The shoulder sleeve 36 of the rolling element cage 30 is shown as receiving and surrounding the shoulder 17 of the insert 11. The insert sleeve 35 of the rolling element cage 30 is shown surrounding at least a portion of the insert lower portion 16 of the insert 11. The rolling elements 50 are shown rollably captured intermediate the insert race 15 of the insert 11 and the collar race 25 of the collar 20. It will be understood that the insert 11 is rotatable within the collar 20.

FIG. 4 also shows how a mid-portion 51 of the insert race 15 of the insert 11 and the mid-portion 52 of the collar race 25 of the collar 30 are each opposite one from the other across each of the plurality of rolling elements 50.

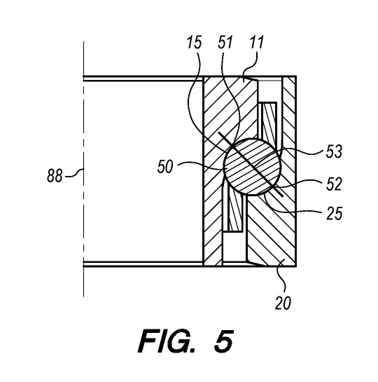

FIG. 5 illustrates that, for the embodiment of the bearing assembly 10 of FIGS. 1-4, a line 53 drawn through the mid-point 51 of the insert race 15 of the insert 11 and the mid-point 52 of the collar race 25 of the collar 20 forms a 45-degree angle with an axis 88 of the throughbore 12 of the insert 11 of the bearing assembly 10. This arrangement is beneficial for distributing lateral and axial impact forces imparted to the bearing assembly 10 that surrounds and protects the drive shaft (not shown) received through the throughbore 12 of the insert 11. It will be understood that a lateral impact on the collar exterior wall 26 of the collar 20 of the bearing assembly 10 during drilling operations is redirected through the rolling elements 50 into a lateral component directed radially inwardly towards the axis 88 and an axial component directed axially against the insert 11 and parallel to the axis 88. It will be further understood that the bearing assembly 10 of FIGS. 1-5 can be retained on a drive shaft (not shown) received through the throughbore 12 by use of conventional locknuts (not shown) secured against the insert top end 18 and against the collar bottom end 23.

The appended drawings depict one embodiment of the present invention, and should not be interpreted as limiting of the present invention, which is limited only the claims that follow and the claims that are included in related applications.

We claim:

1. A bearing assembly, comprising:
an insert having throughbore, an insert race about an exterior of the insert, a shoulder radially protruding from the exterior of the insert, an insert top end, an insert bottom end opposite to the insert top end, an insert lower portion and a throughbore wall;
a rolling element cage disposed adjacent to the insert and having a shoulder sleeve, a cage upper end, a convergent portion, a cage bore, an insert sleeve, a cage lower end, and a plurality of angularly distributed rolling element holes;
a collar having a collar top end, a collar bottom end opposite to the collar top end, a collar exterior wall, a collar race with a radius equal to a radius of the insert race of the insert, a shoulder sleeve bore having an interior wall and an insert sleeve bore having an interior wall; and
a plurality of rolling elements sized for being received into the rolling element holes of the cage and for bearing against the insert race of the insert and the collar race of the collar;
wherein the cage maintains the plurality of rolling elements in and angularly distributed arrangement;
wherein a line through a mid-point of the insert race and a mid-point of the collar race will be at a 45-degree angle to an axis of the throughbore of the insert with the bearing assembly in an assembled condition; and
wherein a rotatable drive shaft is received through the throughbore of the bearing assembly.

2. A bearing apparatus, comprising:
a plurality of bearing assemblies, each bearing assembly including:
an insert having throughbore, a bearing race about an exterior of the insert, a shoulder radially protruding from the exterior of the insert, an insert top end, an insert bottom end opposite to the insert top end, an insert lower portion and a throughbore wall;
a rolling element cage disposed adjacent to the insert and having a shoulder sleeve, a cage upper end, a convergent portion, a cage bore, an insert sleeve, a cage lower end, and a plurality of angularly distributed rolling element holes;
a collar having a collar top end, a collar bottom end opposite to the collar top end, a collar exterior wall, a collar race with a radius equal to a radius of the insert race of the insert, a shoulder sleeve bore having an interior wall and an insert sleeve bore having an interior wall; and
a plurality of rolling elements sized for being received into the rolling element holes of the cage and for bearing against the insert race of the insert and the collar race of the collar;
wherein the cage maintains the plurality of rolling elements in and angularly distributed arrangement; and
wherein a line through a mid-point of the insert race and a mid-point of the collar race will be at a 45-degree angle to an axis of the throughbore of the insert with the bearing assembly in an assembled condition;
wherein the bearing apparatus includes a bore comprising the plurality of aligned throughbores of the plurality of inserts; and
wherein a rotatable shaft is received through the bore of the bearing apparatus.
